(19) United States
(12) Patent Application Publication
(10) Pub. No.: US 2005/0179670 A1
(43) Pub. Date: Aug. 18, 2005

(54) One-touch input portable electronic device running one-touch system

(76) Inventor: Michael Chiang, Taipei (TW)

Correspondence Address: BIRCH STEWART KOLASCH & BIRCH, PO BOX 747, FALLS CHURCH, VA, 22040-0747, US

(21) Appl. No.: 10/778,544

(22) Filed: Feb. 17, 2004

(51) Int. Cl. G09G 5/00

(52) U.S. Cl. 345/173

(57) ABSTRACT

A one-touch input portable electronic device running one-touch system includes input devices that consist of a built-in keyboard which contains numeral keys 0-9 and a hand-written pad to enable users to execute a preset customized application program and enter a numeric signal by depressing a single key (numeral keys 0-9) and couple with a hand-written pad to enter character and graphic signals so that users can process and control operation in a most convenient, fast and intuitive manner.

### FIELD OF THE INVENTION

The present invention relates to a portable electronic device and particularly to a one-touch input portable electronic device running one-touch system.

### BACKGROUND OF THE INVENTION

With the arrival of the information age, a wide variety of portable electronic devices has been developed and introduced. Either in work or daily life, those portable electronic devices have been deeply woven in every aspect of people's life, and become almost important. These days many software systems provided by the portable electronic devices have evolved from simple and basic functions to novel and more complex functions. But for most users, especially those who do not have extensive knowledge of computer hardware and software, those novel and complex application software technologies and functions could be very baffling. As a result, many users encounter a great difficulty during learning and using. Some people are so frustrated, they lose the desire of learning.

Currently, to execute some application programs in an operating system mainly is accomplished by moving the mouse to the selected application program, then point the mouse level by level into the program to be executed. For instance, to execute “Start/Program Set/Affiliated Application Program/Graphic Software”, the user has to point the mouse at the “Start” icon at the left and lower corner of the screen, and enter “Program Set”, and select “Affiliated Application Program” at the next level, then enter “Graphic Software”. In the process of using the mouse to enter the desired application program by level approach, for each level of the application program being selected, the computer will display all the application programs on that level for the user to make a selection. The user has to take time to select the desired one among many application programs on each level. It is a time-consuming operation; it also causes a lot of inconveniences.

To remedy the foregoing problems, there is a one-touch system developed to enable users to customize function keys according to individual preference. Users can press the function keys to rapidly activate the desired application program and save a lot of complicated operation procedures. The one-touch system can also reduce user's resistance to learning operation procedures of portable electronic devices.

While the one-touch systems, now available on the market, can greatly simplify the complicated operation procedures for activating and using application programs, many application programs still resort to entering character signals to complete the operation. For instance, the portable electronic devices now on the market such as notebook computers that provide a built-in input device for generating character and graphic signals mostly have a built-in keyboard or touch pad containing seventy-two input keys. Users have to learn the commonly adopted input methods (such as phonetic notation input) to generate character signals from the built-in keyboard. And a number of individual keys that represent the corresponding phonetic notations should be pressed consecutively to generate one character signal. This is a tedious operation, especially to users of older ages who learn new techniques slowly and are less agile physically, and usually have weaker eyesight. Some older people might still have sufficient reading and writing ability, but are unfamiliar to the conventional input methods (such as the phonetic notation input has to know the technique of combining sound into syllables based on phonetic notations). On the other hand, using a touch pad often encounters a constraint of the relative small size of the touch pad and fine drawing lines. Users wanted to use the built-in input devices to generate character and graphic signals. They have to learn operating two types of input devices. This is a heavy burden to novices. It could become too overwhelming and diminish users' learning desire. Hence for the general portable electronic devices such as notebook computers, although the provided built-in input devices aim at making the one-touch system simple, fast and operable intuitively, the result is not satisfactory.

Based on the examples mentioned above, it is known that some users use the portable electronic device equipped with a built-in keyboard that runs one-touch system, mainly to execute a few function keys (0-9 numeral keys) of the one-touch systems. The keyboard with input keys for generating character signals does not fully achieve the desired functions.

For the conventional portable electronic devices such as notebook computers, the input keys (seventy-two keys) on the built-in keyboard to generate character signals are unlikely to be reduced significantly, due to functional requirements. To take into account the user's convenience, the built-in keyboards of the portable electronic devices mostly have a constant size. At present, with fast developments of integrated electronic elements and growing market demands, the portable electronic devices have become slimmer and lighter. Since the dimension of the built-in keyboard has limitations as previously discussed, the portable electronic device also has size constraint.

### SUMMARY OF THE INVENTION

Therefore, the object of the present invention is to provide a one-touch input portable electronic device, running one-touch system that has a built-in keyboard which can execute application programs by pressing a few numeral keys and generate numeric signals. It can be coupled with built-in input devices, so any user who is capable of reading and writing can easily generate character and graphic signals. Thereby not only the size of the portable electronic device may be made more compact, user's learning difficulty can also be overcome. It also can filly exploit the benefits of one-touch system and provide users a most simple, fast and intuitive operation and control. In order to achieve the foregoing object, the one-touch input portable electronic device according to the invention includes an one-touch input module, a touch pen, a hand-written pad and a one-touch system (OTS) module.

Users can use the one-touch input module to set and generate customized function keys to execute related application programs and generate numeric signals, and to generate numerals and graphic symbols by touching through the touch pen and hand-written pad. The OTS module to execute related operation procedures can receive the signals.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the one-touch input portable electronic device running one-touch system according to the invention;

FIG. 2 is an operation block diagram of a first embodiment of the invention for executing an application program in a window of an OTS; and

FIG. 3 is an operation block diagram of a second embodiment of the invention for executing an application program in a window of an OTS.

### DESCRIPTION OF THE PREFERRED EMBODIMENTS

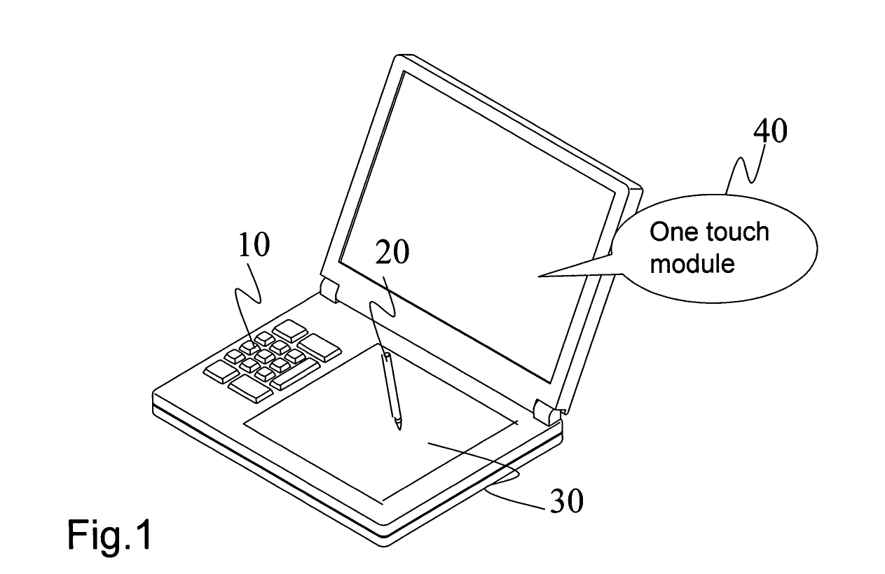

A one-touch input portable electronic device running one-touch system according to the invention provides built-in input devices that consist of a built-in keyboard, which contains 0-9 numeral keys and a hand-written pad. Users can press a single key (i.e. 0-9 numeral keys) to execute preset customized application programs and enter numeric signals, and use the hand-written pad to enter character and graphic signals so that users can process and control operations in a most convenient, fast and intuitive fashion. Refer to FIG. 1 for a one-touch input portable electronic device running a one-touch system according to the invention. It includes a one-touch input module 10, a touch pen 20, a hand-written pad 30 and a one-touch system (OTS) module 40.

The one-touch input module 10 includes ten numeral keys 0-9, an escape key (Esc key), a space key, and an enter key. The numeral keys 0-9 may match the one-touch functions provided by the OTS module 40, so that users can execute a preset function through a “single action” (usually by selecting a “single key”, i.e. function key), such as sending e-mail, using a FAX, logon networks, and the like. The numeral keys 0-9 may also be used for entering numeric signals.

The touch pen 20 enables users to touch (couple) the hand-written pad 30 so that the hand-written pad 30 generates a corresponding input signal (character and graphic signal).

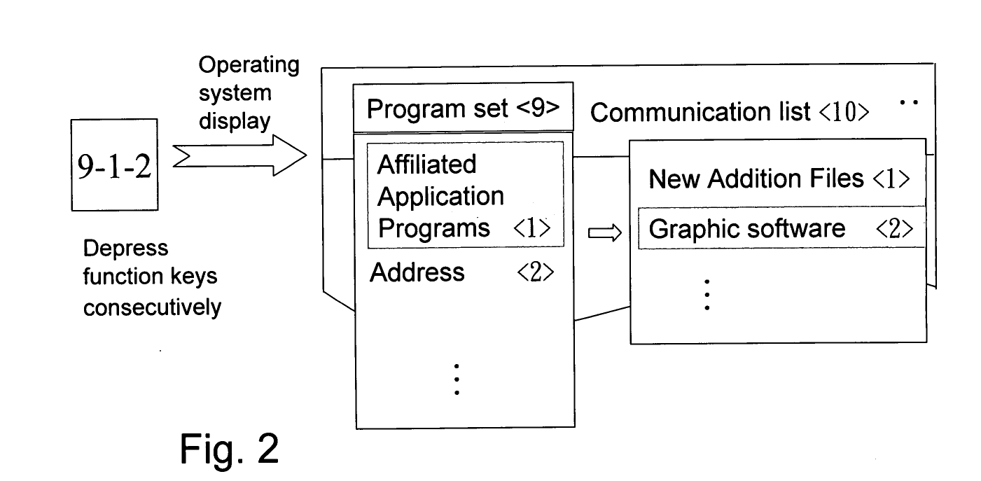

The hand-written pad 30 generates corresponding character and graphic signals according to contact conditions with the touch pen 20 entered by users. Hence, when users want to use the one-touch input module 10 to activate a selected application program under the OTS module 40, or enter input signals (characters and graphics) after a selected functional item under an application program has been activated, the touch pen 20 and the hand-written pad 30 provide the means to generate the required signals. The OTS module 40 receives the signals triggered by the customized function keys in the one-touch input module 10 and the input signals (characters and graphics) generated by contact between the touch pen 20 and the hand-written pad 30. In addition, the OTS module 40 activates a corresponding application program in the OTS module 40 according to the triggered signals of the function key and input signals, or displays the input signals on the corresponding application program. Refer to FIG. 2 for a first embodiment of the invention of the process for executing an application program in a window under OTS.

If a scenario of a user intends to execute “Program Set/Affiliated Application Program/Graphic Software”, the user can enter the window of the operating system through a preset function key on the one-touch input module 10; press function key [9] on the one-touch input module 10 to enter “Program Set”; then press function key [1] on the one-touch input module 10 to enter “Affiliated Application Program”; finally press function key [2] on the one-touch input module 10 to enter “Graphic Software”. Then the user can directly enter the window of “Graphic Software”. There is no need to wait for the display of every level. When the OTS module 40 activates “Graphic Software”, the user can use the touch pen 20 and the hand-written pad 30, to generate the desired character and graphics input signals.

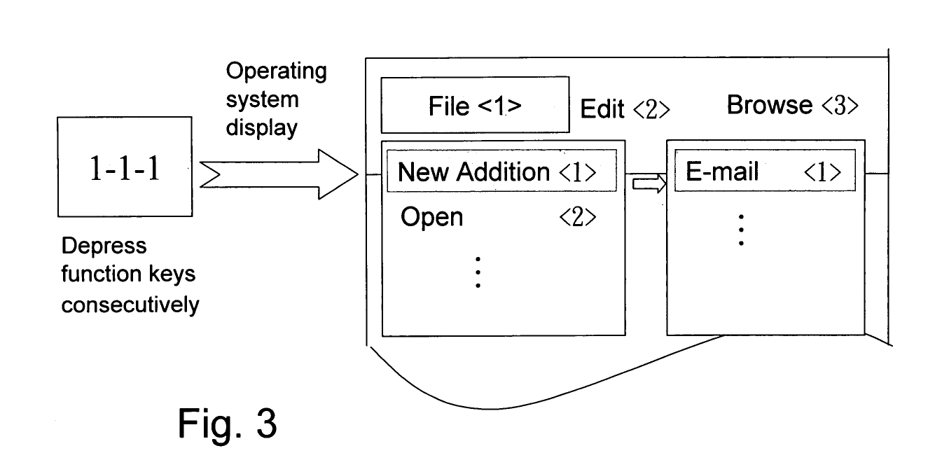

Refer to FIG. 3 for a second embodiment of the invention of the process for executing an application program in a window under OTS.

If a scenario of a user intends to execute a functional item of “Build New Mail” in a mail receiving and sending software, the user can enter the window of a mail editing software through a preset function key on the one-touch input module 10. Press [1] to enter function selection item “File”; then press [1] to enter “New Addition”; finally press function key [1] to enter “E-Mail”. Then the user can use the touch pen 20 and the hand-written pad 30 to generate the desired character and graphics input signals. There is no need to select one functional item and wait for the display of the next page to do another selection. Thus the user uses less time and operation activities are simplified. While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

1. A one-touch input portable electronic device running one-touch system, comprising:
a one-touch input module including at least one function key which is depressible to trigger execution of a corresponding function;
a touch pen;
a hand-written pad to be in coupling with the touch pen to generate an input signal; and
a one-touch system module for receiving the input signal and triggering of the function key to activate execution a desired operation.

2. The one-touch input portable electronic device running one-touch system of claim 1, wherein the one-touch input module includes numeral keys from 0 to 9, an escape key, a space key and an enter key.

3. The one-touch input portable electronic device running one-touch system of claim 2, wherein the one-touch input module further includes a power supply key.

4. The one-touch input portable electronic device running one-touch system of claim 1, wherein the input signal is a character/graphic signal.

5. The one-touch input portable electronic device running one-touch system of claim 1 further including a sensitive panel to couple with the touch pen to generate the input signal.
